(19) United States
(12) Patent Application Publication
(10) Pub. No.: US 2007/0117956 A1
(43) Pub. Date: May 24, 2007

(54) Bismaleimide resin with high temperature thermal stability

(76) Inventors: Jack Boyd, Silverado, CA (US); Christopher L. Bongiovanni, Long Beach, CA (US); Bryan Thai, Fontana, CA (US)

Correspondence Address: Robert R. Neller;Cytec Industries Inc., 1937 W. Main St., P.O. Box 60, Stamford, CT, 06904, US

(21) Appl. No.: 11/340,981

(22) Filed: Jan. 27, 2006

Related U.S. Application Data
(60) Provisional application No. 60/653,407, filed on Feb. 16, 2005.

(51) Int. Cl. C08G 73/00

(52) U.S. Cl. 528/170

(57) ABSTRACT

The present invention is for the use of aliphatic bismaleimide compounds in epoxy resin systems to increase the thermal aging properties of a cured resin system through reduced microcracking as measured by reduced weight loss after thermal aging. The present invention further provides a BMI resin formulation with no undissolved solid BMI, but which retains equivalent mechanical properties as BMI resin formulations incorporating slurried solid BMI particles.

### BACKGROUND OF THE INVENTION

1. Field of the Invention

This invention relates to bismaleimide (BMI) resins for use in complex and diverse high performance composite applications. In preferred embodiments, this invention relates to a composition of BMI with improved thermal aging stability and tack properties through the incorporation of a liquid aliphatic BMI to the resin, in particular hexamethylene diamine bismaleimide (HMDA-BMI), as an oxidation inhibitor and viscosity modifier.

2. Description of the Related Art

Laminated polymer matrix composite structures are widely used in a number of applications. For example, increasing amounts of composite structures are being used in high performance aerospace applications. However, some of these applications require high thermal durability of the finished composite with improved tack during part manufacturing lay-up of the composites.

Most polymer matrix composite parts in the aerospace industry use epoxy resins because of epoxy's good combination of mechanical properties, wide service temperature range, and ease of part manufacture.

However, polymer matrix composites parts used in extreme environments such as high temperature applications, lack adequate thermal durability. Currently, there are no cost effective polymer matrix composite parts that can withstand these extreme environments. The highest temperature polymer matrix composite resin currently used is PMR-15, a version of which is sold as CYCOM® 2237 by Cytec Engineered Materials Inc. of Anaheim, Calif. Since the development of PMR-15 there has been extensive work to find a PMR-15 replacement to overcome severe limitations restricting its use. The limitations of PMR-15 result in micro-cracks and expensive processing. An additional limitation with PMR-15 is that it contains 4,4′-Methylenedianiline, MDA, a health hazard requiring extensive environmental controls.

Where aerospace applications require service temperature beyond the capability of epoxy resins, BMI resins are gaining acceptance because of their cost effective epoxy-like processing properties and high temperature durability. Current BMI resins offer higher use temperature, but not as high as PMR-15. BMI resin based composites possess excellent mechanical properties in the 149° C. to 232° C. temperature range with no microcracking and no environmental hazards. For example, Cycom® 5250-4 BMI resin prepreg is offered by Cytec Engineered Materials Inc. of Anaheim, Calif., as a high temperature aerospace primary structure construction material. However, while its Tg is higher than epoxies, its Tg is not as high as PMR-15 and is insufficient for many high temperature applications.

BMI resins have been modified through the co-reaction of 2,2′-diallylbisphenol A (DABA) with aromatic bismaleimides, most specifically bismaleimide incorporating 4,4′-methylenedianaline (MDA-BMI) in order to achieve high temperature performance. This process is more fully described in U.S. Pat. No. 4,100,140 with additional BMI resins described in U.S. Pat. No. 5,003,018 and U.S. Pat. No. 5,747,615 that incorporate additional solid, undissolved BMI resulting in enhanced tack and drape properties. These BMI resins give superior mechanical properties, especially high temperature performance, and ease of processing into complex composite parts, but without the limitation of incorporating the health hazard MDA as in PMR-15.

While this prior art generally discloses that hexamethylene BMI (HMDA-BMI) may be incorporated into a BMI resin system, there is no teaching that such an addition would enhance thermal stability, reduce viscosity or improve tack. Indeed, the art suggests that incorporation of an aliphatic BMI such as HMDA-BMI would reduce the Tg and would thus, not be appropriate. Moreover, there was no teaching that through the addition of an aliphatic BMI to the resin system, more aromatic BMI could be dissolved, and thus incorporated into the resin without detriment to the out time, while reducing viscosity to allow full impregnation of carbon fibers during prepreg manufacturing.

Other improvements in BMI technology were advanced by Technochemie disclosed as a eutectic blend of the aromatic bismaleimides from MDA-BMI and toluene diamine (TDA-BMI) with an aliphatic bismaleimide derived form 2,2,4-trimethlyhexamethylene diamine (TMH-BMI) in a ratio of about 50/25/15 for MDA-BMI/TDA-BMI/TMH-BMI. These formulations are described more fully in U.S. Pat. No. 4,211,861 and U.S. Pat. No. 4,211,860. However, none of these disclose or suggest use of an aliphatic BMI to increase thermal stability, reduce viscosity or improve tack.

Another limitation is that thermoplastics are not able to be dissolved in current BMI resin systems because of the inherent high viscosity of current BMI resins systems. The dissolution of an effective amount of thermoplastics in current BMI resin systems increases the resin viscosity to such a level that the resulting resin formulation is out of range of practical application.

Another limitation of current BMI resin formulations is that they often lack adequate flow control for making honeycomb sandwich parts when incorporated into composite prepregs.

Improvements in BMI resins have been investigated to improve flow control through the addition of TMH-BMI, Cabosil, and a polyimide thermoplastic, Matrimid 5218. Such a system is commercialized in a product called Cycom® 5250-4 Low Flow BMI resin based prepreg offered by Cytec Engineered Materials Inc. However, such a system continues to lack high thermal stability of the final composite. While some art suggested that TMH-BMI should result in enhanced tack properties, it did not lower the viscosity enough during processing of the prepreg to fully impregnate the fibers and provide a material with enough tack.

Impregnation is a property of composite prepreg that refers to the lack of dry fibers in the prepreg and is especially important for slit tape prepreg applications. Slit tape prepreg systems generally require full impregnation in order to effectively bind the carbon fibers to reduce fuzzing during automated layup. As such, current BMI resin systems have the additional limitation of being unable to fully impregnate carbon fiber prepregs due to their high viscosity.

Current BMI based resin systems are also notoriously difficult to fully impregnate because 35 wt % to 46 wt % of the BMI is in the form of undissolved solids, as a slurry in the resin. Thus, there is less liquid resin to fill the voids in the fiber bundles to fully wet the fibers of the prepreg. To fully impregnate a prepreg incorporating a BMI resin, high processing temperatures are required. These processing conditions assure full impregnation, but severely reduce tack making manufacturing applications difficult and requiring use of low speeds on automatic tape lay-up during part manufacturing. Solid BMI particles are taught to be necessary in the resin to ensure sufficient tack for lay-up. However, with more solid particles the out time is reduced to often less than two days before the tack is reduced to unusable levels.

The present invention resolves many of these issues by providing a high temperature composite with increased tack and reduced viscosity to allow for fully impregnated BMI resin based prepreg. The reduced viscosity also allows for the addition of thermoplastic hardeners. The present invention provides increased mechanical and thermal performance characteristics of the final composite. As such, the present invention allows the incorporation of more total BMI in the resin system as well as the incorporation of a thermoplastic to increase elasticity.

The BMI resin system of the present invention has higher temperature durability properties than the prior art. The invention provides elevated thermal aging characteristics of composites while also improving tack during lay-up. The present invention provides a glass transition temperature, Tg, of at least about 342° C. with high temperature mechanical properties equivalent to PMR-15 with the advantages of curing without volatiles, containing no toxic components, and lower viscosity providing for the ability to be used in resin infusion applications; a significant advantage over PMR-15.

### SUMMARY OF THE INVENTION

The present invention is for the use of aliphatic bismaleimide compounds in resin systems to increase the thermal stability of a cured resin composite system by reducing microcracking as measured by reduced weight loss after thermal aging.

The present invention further provides a BMI resin formulation with no undissolved solid BMI, but which retains equivalent mechanical properties as BMI resin formulations incorporating undissolved BMI particles.

The present invention uses aliphatic BMI compounds to surprisingly increase the total BMI content in the resin while maintaining cured resin performance.

The present invention further provides a BMI resin formulation with increased thermal stability while maintaining a low viscosity sufficient to fully impregnate carbon prepreg systems.

A preferred embodiment of the present invention provides for a BMI resin system, comprising a liquid phase and a solid phase, an aliphatic BMI in the liquid phase, and an aromatic BMI, wherein about 1% to about 45% of the aromatic BMI is in the solid phase at the slurry mixing temperature.

A further preferred embodiment of the present invention provides for a BMI resin system, comprising only a liquid phase at the mixing temperature and an aliphatic BMI in the liquid phase that is substantially a monomer.

A further preferred embodiment of the present invention provides for a BMI resin comprising about 2 wt % to 20 wt % aliphatic BMI about 20 wt % to 60 wt % olefinic co-reactant and about 20 wt % to 80 wt % aromatic BMI wherein the resin displays improved stability to thermal aging at 450° F.

Lower resin viscosity improves certain uncured resin characteristics such as improved processing in liquid molding processes. It also improves BMI prepreg and adhesive handling performance such as tack and drape. The lower resin viscosity provided by the present invention has further advantages of allowing modification of the resin by dissolved and particulate thermoplastics to improve the uncured and cured resin characteristics such as elasticity while maintaining the resin viscosity at unusable levels.

It has been surprisingly discovered that hexamethylene diamine bismaleimide (HMDA-BMI) as an oxidation inhibitor and viscosity modifier is preferred.

Prior art suggests that increasing the amount of BMI above 71% is not recommended. Aliphatic BMI's are further taught in the art to generally lower the T_{g} of the cured resin significantly when substituted for an aromatic BMI. However, adding HMDA-BMI allows the percentage of total BMI to be increased to 70% or higher without loss of tack or tack stability. This higher percentage of BMI increases the T_{g} significantly.

Also aliphatic BMI's are not taught in the art to increase thermal stability properties and that they should lower the thermal stability because of lower T_{g} properties. However, HMDA-BMI was surprisingly found to increase thermal stability of the resin and prevent micro-cracking during thermal aging.

### BRIEF DESCRIPTION OF THE DRAWINGS

FIG. 1 illustrates a comparison of the OHC value of a standard BMI with the OHC value of a standard epoxy resin system.

FIG. 2 illustrates the damage tolerance by compression after impact of a standard BMI and of a standard epoxy resin system.

FIG. 3 illustrates the present invention room temperature compression and flexural strength.

FIG. 4 illustrates a comparison of the dry T_{g} of composites formed by a prior art BMI system, the present invention system and a PMR-15 system.

FIG. 5 illustrates the polished cross-section of a composite made from the present invention after thermal shock aging tests showing no micro-cracking.

FIG. 6 illustrates a weight loss comparison after 2000 hours at 232° C. for PMR-15, the present invention and the prior art BMI system.

FIG. 7 illustrates the chemical formulations of various compounds discussed herein.

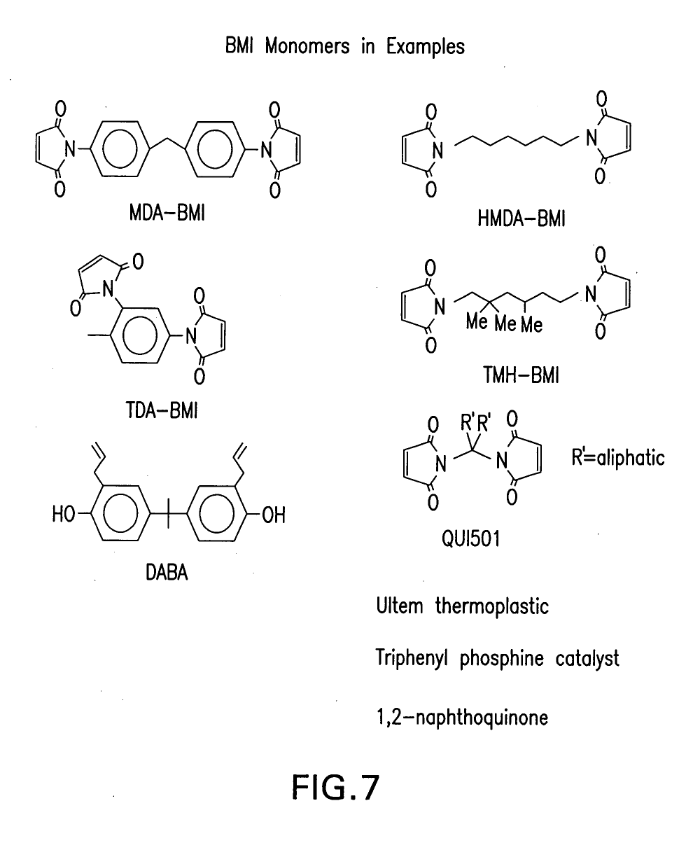

FIG. 8 illustrates a mechanical property comparison of a standard BMI resin based composite and the present invention at two different post-cures (232° C./6 hours and 266° C./6 hours).

### DETAILED DESCRIPTION OF THE PREFERRED EMBODIMENTS

### Definitions

By the term “tack” is meant a property needed when plying the layers of prepregs together and relates to the ability of the prepreg to remain adhered together as needed for complex parts to later compress and heat form into composite parts.

By the term “drape” is meant a property needed when plying the layers of prepreg together and refers to the ability of the prepreg to form into tight radii needed for complex parts.

By the term “flow” is meant a description of resin movement during processing, curing, of prepregs into final composite parts. Low flow refers to high viscosity resin desirable for making honeycomb sandwich composite parts. Low flow allows the resin to stay in the carbon fibers during the curing, heating, process to make the honeycomb composite part.

Low flow, or high viscosity, is typically attained by flow modifiers, viscosity enhancers, especially thermoplastics, which increase the non-Newtonian resin characteristics such as Cabosil®, a thixotrop.

By the term “base resins” is meant resin systems derived from and incorporating bismaleimide resins.

By the term “bismaleimide” or “BMI” is also meant the closely related nadicimides. Preferred bismaleimides are the bismaleimides and nadicimides of toluenediamine, aliphatic amines, methylenedianiline, aliphatic diamines, isophorone diamine, and the like. Further examples of suitable bismaleimides are disclosed in U.S. Pat. Nos. 4,644,039 and 5,003,018. Generally, the bismaleimides are copolymerized with an alkenylphenol comonomer such as o,o′-diallylbisphenol A, o,o′-diisopropenylbisphenol A, allyleugenol, alkenylphenoxybenzophones and the like. When BMI resins are the major thermosetting resin it is frequently desirable to add a low viscosity epoxy resin, for example a bisphenol F epoxy or resorcinol based epoxy to the resin system in minor amounts.

By the term “inhibitor” is meant a compound for reducing the reactivity of the resin components. Appropriate inhibitors are known in the art and the present invention may further incorporate the use of inhibitors as more fully described in U.S. Pat. No. 5,955,566.

By the term “catalyst” is meant a compound for initiating resin component reactivity. Appropriate catalysts are known in the art and some are more fully described in U.S. Pat. No. 4,644,039.

By the term “liquid phase component” or “liquid monomer component” is meant a reactive resin system component which is liquid at the slurry mixing or mixing process temperature. This reactive resin system component may contain but a single reactive monomer, several reactive monomers of the same or different chemical functionalities, cross-curative monomeric or oligomeric modifiers, or in addition to such components, other nonreactive system auxiliary components such as plasticizers, fillers, pigments, thermoplastic tougheners, rheology control agents, tackifiers, and the like.

The uncured liquid monomer component of the subject invention should have a low glass transition temperature, and/or a low softening point. Preferably, the glass transition temperature is about 5° C., or less, although certain applications a higher glass transition temperature may be acceptable, for example for use with automated layup machines equipped with prepreg preheaters. In any case, the glass transition temperature of the finished resin system should be at least about 20°-30° C. below the intended use temperature and preferably lower. Most preferably the glass transition temperature of the liquid monomer component is −10° C. or less.

It is impossible to give an exhaustive list of possible liquid monomers due to the myriad possibilities which exist. However, the following types of liquid monomers may be considered as typical, but not limiting.

Unsaturated polyesters are suitable liquid monomers. These polyesters must be liquid at the slurrying temperature. Such polyesters are prepared by esterifying a polybasic acid and polyfunctional alcohol at least one of which contains ethylenic or acetylenic unsaturation. Such polyesters, to have the lowest melting points, are often synthesized from mixtures of acids and alcohols. Examples of such unsaturated polyesters may be found in Unsaturated Polyesters by Herman Boenig, Elsevier, N.Y., 1964. Many commercial resins of this type are available, often containing other polymerizable species such as styrene.

Isocyanates may be suitable liquid monomers. Examples of suitable isocyanates are the toluene isocyanates, for example 2,4-, and 2,6-toluenediisocyanates and their mixtures; the diisocyanatodiphenylmethanes, for example 2,2′-, 2,4′-, 4,4′-, and 3,3′-diisocyanatodiphenylmethane and their mixtures; isophorone diisocyanate, and polyphenylenepolymethylenepolyisocyanate.

Bismaleimide resins may be suitable liquid monomers, particularly eutectic mixtures of two or more BMIs. Such BMIs are well known items of commerce and may be prepared, for example, through the reaction of maleic anhydride with a suitable di- or polyamine. Useful, for example, are the maleimides of the toluenediamines, the phylenediamines, the diaminodiphenylmethanes, diarninodiphenyloxides, diaminodiphenylsulfides, diaminodiphenysulfones, and their analogues. Also suitable are the maleimides of amine terminated polyarylene oligomers having interspersed oxide, sulfide, sulfone, or carbonyl groups as taught by U.S. Pat. Nos. 4,175,175, 4,656,208 and EP-A-0,130,270.

Aliphatic BMIs of di- and polyamines are also suitable, for example those derived from trimethylhexanediamine (TMH-BMI), hexanediamine (hexamethylene diamine bismaleimide or HMDA-BMI), octanediamine, decanediamine, 1,4-diaminocyclohexane, and isophorone diamine.

Cyanate resins are also suitable liquid monomers. Such resins are prepared through the reaction of cyanogens halide with an aromatic di- or polyol such as recorcinol, hydroquinone, dihydroxynaphthalene, the cresolic and phenolic novalak, and the various bisphenols. Eutectic mixtures of such cyanates are also feasible as liquid monomers.

The above-identified liquid monomers serve to illustrate the variety of chemical types which are suitable for the practice of the subject invention. Other monomers having other chemical functional groups which can meet the requirements of being liquid and substantially unreactive at the slurry mixing temperatures will readily suggest themselves to those skilled in the art.

Mixtures of various monomers may also be used. Examples of such mixtures include epoxy resins and di-or polyphenols; epoxy resins and cyanate resins; cyanate resins and bismaleimide resins, and epoxy resins and isocyanate resins. All such resin mixtures should be capable of mutual solubility at the slurry mixing temperature; should not react substantially at the slurry mixing or mixing temperature; and where any of the components are solids, those components should not be present in an amount appreciable in excess of the storage temperature solubility of that component, or to such a degree as to elevate the glass transition temperature of the uncured resin system to unacceptable levels.

The reactive monomers of the liquid phase component may be co-reactive in that they do not react with each other, but react upon cure with themselves or other system components, or they may be cross-curative, in that they react with each other upon reaching the cure temperature. The reactive monomers of the liquid monomer component, however, must not react to any substantial degree during the slurry mixing process, or premature advancement of the resin may occur.

Tougheners such as the o,o′-diallybisphenols and the o,o′-dipropenylbisphenols, or allylphenoxy, propenylphenoxy, allylphenyl and propenyphenyl-terminated oligomeric toughening agents may be incorporated into liquid monomers containing bismaleiides. Other ingredients may also be added into liquid monomers. Where such other modifiers are solids, as is the case with some of the oligomeric toughening agents, the quantity contained in the liquid phase must be such that the storage temperature solubility of the modifier is not appreciably exceeded.

By “substantial degree of reaction” is meant a degree such that the resin system is advanced so as to no longer be suitable for the preparation of film adhesives, hot melt prepregging films, or for the direct impregnation of fiber reinforcement from the melt. In these cases, the resin essentially is no longer thermoplastic, is a thermoplastic of such high melting point that the final cure occurs if one of the uses identified immediately above is attempted, or is of such high viscosity at suitably elevated temperatures that hot melt or film impregnation is not possible.

By “slurry compatible solid” is meant a reactive solid monomer or a thermoplastic toughener. In the case of thermoplastic tougheners, the thermoplastic may be soluble or insoluble at the cure temperature. If soluble, the thermoplastic will dissolve at a temperature higher than the slurry mixing temperature, but not at the slurry mixing temperature itself. Alternatively, the thermoplastic may be substantially soluble at the slurry mixing temperature, but the slurry process may be performed over a time such that only a minimal amount of the thermoplastic will dissolve. In either case, the thermoplastic must be a solid at the slurry mixing temperatures.

If the slurry compatible solid is a reactive monomer it will have a molecular weight greater than about 250 Daltons and preferably will have the same reactive functionality as the majority of the reactive chemical monomers in the finished resin system. The reactive slurry compatible solid will also be chemically and physically compatible with the liquid comonomer in the sense hereinafter designated.

By the term “slurry mixing process temperature” is meant any temperature at which mixing may occur and maintain the intended solid phase component in substantially the solid phase. This temperature may be from 70° F. to 280° F., preferably about 120° F. to about 200° F., and most preferably between about 140° F. and 160° F.

By the term “mixing process temperature” is meant any temperature at which mixing may occur and maintain substantially a single liquid phase of the resin mixture and can similarly be from 70° F. to 280° F., preferably about 120° F. to about 200° F., and most preferably between about 140° F. and 160° F.

By “chemically compatible” is meant that the reactive monomer will not react, or “cross-cure” to any substantial degree with the other monomer(s) at the slurry mixing process temperature or mixing process temperature. Preferably the chemical functionality is the same as the major portion of the liquid monomer. When the chemical functionalities are not the same, the slurry compatible solid must not be reactive with the major liquid monomer as the reactions of these respective groups are commonly viewed. Examples of systems where the slurry compatible solid and the liquid monomer have the same functionalities include the slurry mixing of a solid epoxy resin into a liquid epoxy resin or the slurry mixing of a solid cyanate resin into a liquid cyanate resin. An example where the respective functionalities are not the same would be the slurry mixing of a solid bismaleimide into a mixture of an epoxy resin and diphenol. Examples of slurry compatible solids which are not chemically compatible and thus, outside the scope of the subject invention are diaminodiphenylsulfone or diaminodiphenylketone when used as curing agents for epoxy resin systems.

By “physically compatible” is meant that a reactive monomer slurry compatible solid must be substantially soluble in the total resin system at some temperature equal or lower than the curing temperature, but “not substantially soluble” under slurry mixing conditions.

By “not substantially soluble” is meant that the quantity of reactive monomer slurry compatible solid which dissolves in the liquid monomer during the slurry mixing process, when combined with any amount of the same monomer already present as a component of the liquid monomer, does not appreciably exceed the storage temperature solubility of that component in the total resin system such that particles of size greater than 20 μm are formed during cooling or upon storage. Preferably, the reactive monomer slurry compatible solid will by substantially insoluble under slurry mixing conditions, meaning that virtually none will dissolve, due either to the low mixing temperature, a short mixing time, or both.

For example, in a bismaleimide resin system composed of several bismaleimides and a comonomer such as diallylbisphenol A, the liquid monomer might contain diallylbisphenol A, alkenylphenoxybenzophones and the like, and several bismaleimides in solution. If a further amount of one of these bismaleimides is slurried into the liquid monomer, it is desirable that virtually none of the added, solid bismaleimide, dissolve. However, some dissolution is allowable, as long as, upon cooling, the solubility of that particular component is not appreciably exceeded, i.e. substantial numbers of crystals or crystallites of a size greater than 20 μm, preferably 10 μm, are not formed.

Examples of components which are reactive, but are not slurry compatible solids in epoxy resin systems as herein defined are the various aromatic diamine curing agents, such as diaminodiphenylsulfone, and dicyandiamide. These compounds do not meet the molecular weight limitations necessary to be a “slurry compatible solid,” and also will cross-cure with a major portion of the liquid monomer. Such curing agents may be slurry mixed with the liquid monomer if desired, so long as a slurry compatible solid as herein defined is also slurry mixed. Other examples of components which are not “slurry compatible solids” in epoxy systems as defined by the subject invention, are the aliphatic diamines, even those of high molecular weight, as these compounds are too reactive and would undesirably advance the resin at the slurry mixing temperature.

Further examples of potential components which are not slurry compatible solids are solid elastomers such as the carboxyl and amino terminated acrylonitrile/butadiene/styrene elastomers, for example those sold under the designation HYCAR.RTM. rubber, a trademark of the B. F. Goodrich Chemical Co., 6100 Oak Tree Blvd., Cleveland, Ohio 44131. These elastomers are insoluble and infusible in most systems, and hence are neither a thermoplastic slurry compatible solid nor a reactive monomer slurry compatible solid.

By the term “epoxy resins” is meant epoxy resins having functionalities of about two or greater are suitable. Examples of liquid epoxy resins are contained in many references, such as the treatise Handbook of Epoxy Resins by Lee and Neville, McGraw-Hill, and Epoxy Resins, Chemistry and Technology, May, Ed., Marcel Dekker, ©1973. Included among these liquid systems are many of the DGEBA and DGEBF resins, the lower molecular weight phenolic and cresolic novalac based resins, and the trisglycidyl aminophenol resins. Mixtures of these liquid epoxy resins and minor amounts of solid epoxy resins such as tetraglycidyl methylenedianiline (TGMDA) or other solid epoxy resins may also be useful. In this case, the amount of solid epoxy resin should be such that neither the storage temperature solubility of the solid epoxy in the remaining liquid monomers is appreciably exceeded, nor is the glass transition temperature of the uncured resin system raised to an unacceptably high value.

Mixtures of epoxy resins and epoxy curing agents which are soluble in the epoxy and unreactive or poorly reactive at the slurry temperature may also be used. Examples of such systems are those containing one or more of the various glycidyl-functional epoxy resins, and aromatic amine curing agents such as diaminodiphenylmethane, diaminodiphenylsulfide, diaminodiphenyloxide, and diaminodiphenylsulfone, particularly the latter. However, as some of these aromatic amines are solids, the same limitation applies to them as applies to mixtures containing solid epoxies: the amount of solid curing agent dissolved in the liquid monomer component should be such that the storage temperature solubility of the curing agent in the remaining liquid monomer components is not exceeded, and the glass transition temperature of the uncured resin system should not be raised to unacceptable values.

By the term “olefinic co-reactant” is meant co-reactants such as 2,2′ diallylbisphenol A (DABA) and others as described in U.S. Pat. No. 4,100,140 and U.S. Pat. No. 5,003,018.

By the term “slurry mixing process” is meant a slurry mixing process under a variety of conditions. Preferably, the slurry compatible solid is finely ground by conventional methods and dispersed into the additional resin components by suitable dispersing means. For example, the solid may be ground to fine particle sizes in a jet mill as disclosed in U.S. Pat. No. 4,607,069. Most preferably, the solid is ground to a particle size less than 20 μm, preferably less than 10 μm. The finely ground resin may then be dispersed, for example using a high shear mixer, at temperatures ranging from below ambient to over 200° C. depending upon the reactivities and viscosities of the liquid monomer components.

Alternatively, the slurry compatible solid may be added to the liquid monomer in small particles ranging from 5 μm, to 3 mm in size, with further size reduction accomplished by use of high shear mixing. An apparatus suitable for such high shear size reduction are the ULTRA-TURRAX.RTM. mixers available from IKA-Maschinenbau Janke and Kunke, GMBH and Co. KG., D-7812 Bad Kruzinger 2, Federal Republic of Germany. Such high shear mixers generate considerable heat, and thus cooling is often necessary to prevent the slurry mixing temperature from rising so high that the solid dissolves in the liquid monomers or that premature reaction occurs.

An additional means of slurry mixing which is possible when the solid component has a relatively steep solubility curve in the liquid monomers and does not tend to form supersaturated solutions, is to melt the solid monomer in a separate container and add it to the liquid monomers while cooling under high shear. With some systems, it may even be possible to melt all the components together and cool while mixing under high shear. This method is not suitable, however, when supersaturation is likely, as the resulting heat-curable resin system is at most metastable and may alter its morphology in an unpredictable manner due to crystallization of the supersaturated components. The temperature of the liquid monomer using this technique, must be below the solidification temperature of the slurry compatible solid when mixing ceases, and in such cases, the “slurry mixing temperature” is this latter temperature.

In any event, following the slurry mixing process, the resulting resin system consists of a continuous phase containing the liquid monomer(s) and a discontinuous (solid) phase containing a major portion of the slurry compatible solid in the form of particles having a mean size of less than about 50 μm, preferably less than 20 μm, and most preferably, less than 10 μm.

By the term “thermoplastics” is meant the preferred engineering thermoplastics such as the polyimides, polyetherimides, polyesterimides, polysulfides, polysulfones, polyphenylene oxides, polyethersulfones, polyetherketones, polyetheretherketones, polyetherketoneketones, polyketonesulfones, and similar polymers. Such thermoplastics preferably have glass transition temperatures greater than 150° C., preferably greater than 250° C.

### Formulation

The present invention involves formulations that incorporate aliphatic BMI monomers to BMI base resin systems to improve microcracking resistance of cured composite structures as measured by reduced weight loss after thermal aging, while not decreasing cured Tg and reducing uncured Tg and viscosity. This reduced uncured Tg aids in the processing of the prepreg into complex shapes by hand or automated processing methods.

Optimal aliphatic BMIs were surprisingly found to be essentially free of oligomers for the optimum viscosity reduction of the uncured resin.

A preferred aliphatic BMI is HMDA-BMI in an amount up to about 40 wt % of the resin formulation, preferably between 2 wt % and 20 wt %, and most preferably between about 5 wt % and about 10 wt %. Another preferred aliphatic BMI is TMH-BMI that is substantially monomers, essentially free of oligomers.

The present invention is preferably used in combination with aromatic BMIs, preferably for example, MDA-BMI or TDA-BMI. U.S. Pat. Nos. 5,003,018 and 5,747,615 more fully disclose a slurry mixing process where some or all of the aromatic BMIs are ground and added to the resin composition as fine particles. The aliphatic BMI is then part of the liquid phase component.

The present invention allows for higher total amounts of aromatic BMI to be incorporated into the formulation. Aromatic BMI may be from about 20 wt % to about 90 wt % or more of the resin formulation, preferably between 50 wt % and 90 wt %, and most preferably between about 60 wt % and about 75 wt %.

The present invention further allows for use of less than 70 wt % slurry mixed solid aromatic BMI monomer and preferably less than about 50 wt %.

The less aromatic BMI monomer slurry mixed into the formulation, the better the tack stability. Additionally, automatic lay-up is improved due to a reduction in fuzzing of fibers caused by dry fibers and low impregnation.

A further benefit of the aliphatic BMI monomer in the resin liquid portion is that it allows the use of high molecular weight thermoplastics which give the uncured resin “elastic” properties. The present invention allows for the addition of thermoplastics in the amount of about 1 wt % to about 20 wt %, preferably 1 wt % to about 5 wt %.

The present invention can be applied to any BMI resin system to improve handling characteristics. This chemical could also modify epoxies and other resin systems which could increase cured Tg and thermal properties without reducing handling characteristics.

### Characteristics

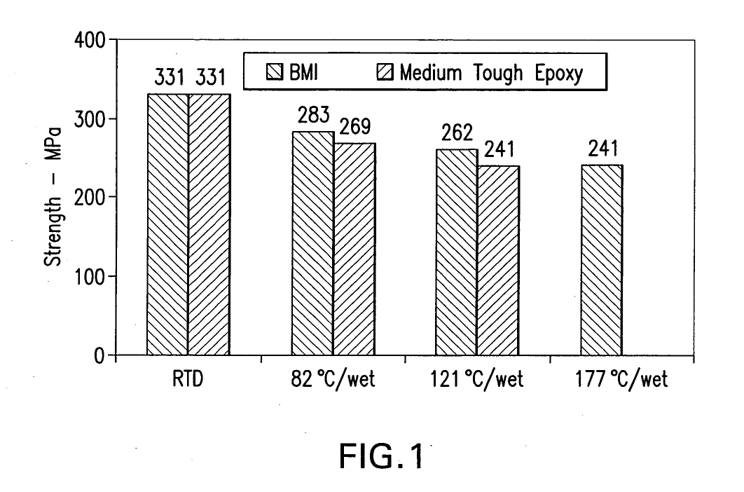

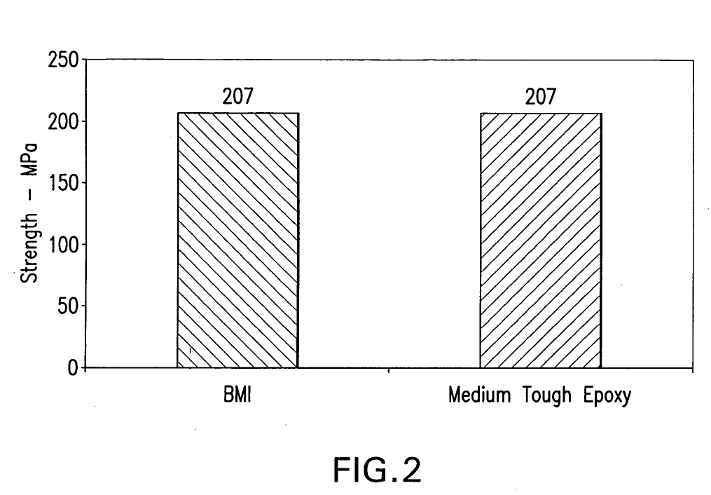

FIG. 1 and FIG. 2 illustrate the mechanical properties of composites formed using a BMI resin and a standard epoxy resin. While most composites demonstrate similar fiber dominated properties regardless of the resin utilized, matrix resins differ by service temperature and damage tolerance. FIG. 1 and FIG. 2 illustrate a comparison of mechanical properties of composite made from a widely used BMI, CYCOM® 5250-4 as illustrated in Example 8, and a composite made from an epoxy resin.

Service temperature is often defined as the temperature at which the open-hole compression (OHC) strength of fully moisture saturated specimen declines from the typical ambient value of 310 MPa to 207 MPa. However, there is no industry standard measurement of composite service temperature.

FIG. 1 illustrates that a BMI provides higher OHC than an epoxy at all service temperatures. This figure compares the OHC value of a standard BMI with a service temperature capability of at least 177° C., with the OHC value of a standard epoxy. The OHC data indicates that parts designed to compressive strength, will either be lighter or have greater safety margins using BMI composites than epoxies.

FIG. 2 illustrates that BMI resin based composites provide equal damage tolerance to medium toughness epoxies. This figure compares a BMI resin with an epoxy resin in damage tolerance compression after impact at 1500 in-lb/in.

Medium toughness is defined by residual compression strength after impact (CAI) of about 207 MPa. This damage tolerance level is considered adequate for most applications. Although medium toughness epoxies exhibit a good balance of damage tolerance and wet elevated temperature mechanical properties, the service temperatures are generally limited to 93° C. to 121° C. Recently the aerospace industry has started using “medium toughness epoxies” as the baseline for new applications.

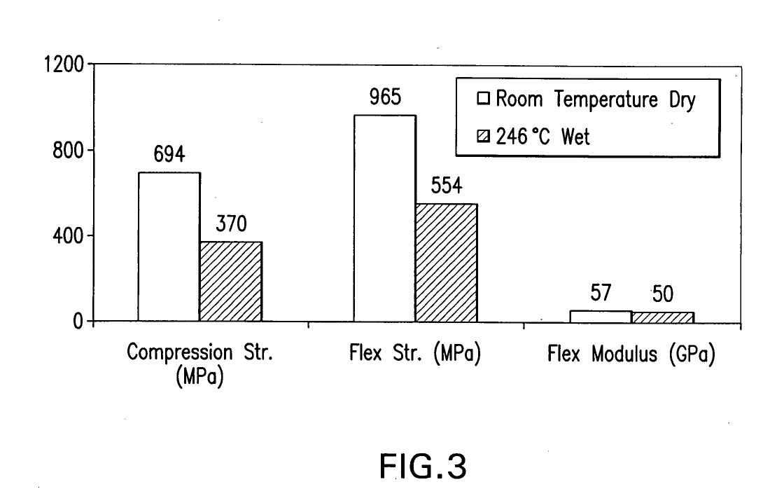

FIG. 3 illustrates the BMI of the present invention at room temperature compression and flexural strength under hot/wet conditions. At 246° C. (wet) the retention is greater than 50% for both tests. This indicates a use capability of at least 246° C. (wet). The aerospace industry has accepted that a minimum 35% retention of mechanical properties at elevated temperature/wet (moisture saturation) to be acceptable for use at that temperature. Wet T_{g} data is often difficult to measure accurately, however the high retention of flex modulus as illustrated in FIG. 3 shows little decline, indicating that the wet T_{g} exceeds 246° C. (wet).

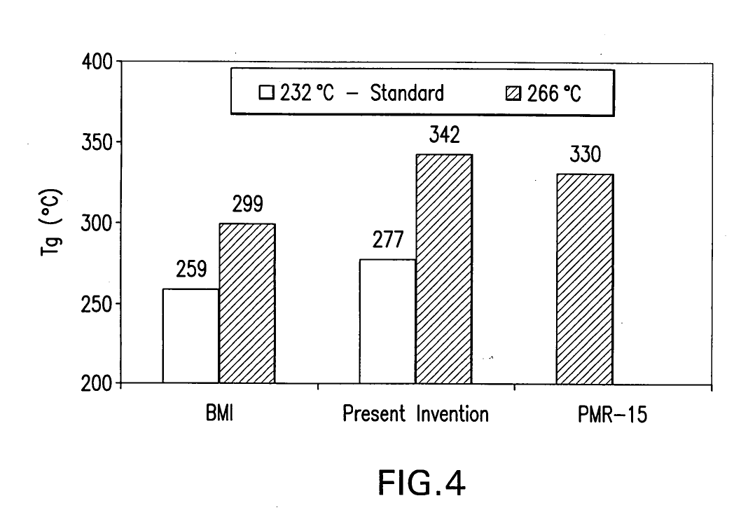

FIG. 4 shows that the dry T_{g} of the BMI of the present invention is higher than standard BMIs and of PMR-15 resin systems. This figure compares the dry T_{g} of a BMI of the present invention (Ex. 11) with a standard BMI resin (Ex. 8) and a PMR-15 resin.

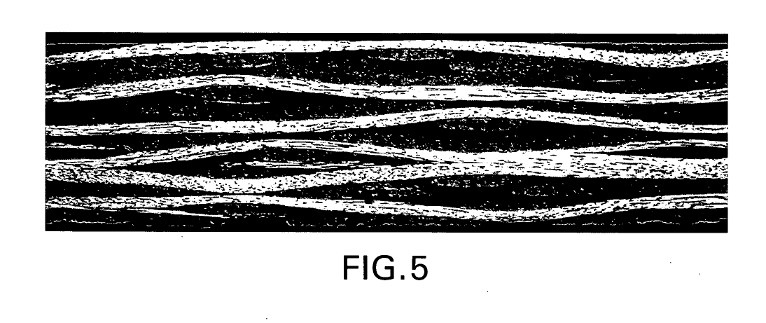

FIG. 5 shows a polished cross-section of a composite panel using a BMI of the present invention after thermal shock. As illustrated, no microcracking has occurred.

One measure of durability is the resistance to oxidation during elevated temperature aging in air. The mechanism of weight loss is the outer most plies are oxidized during aging. For composites comprised of prior art BMI resins it has been found that this weight loss starts becoming a concern above about 177° C. The present invention applications are at 232° C. and above. The industry standard maximum weight loss is 2%.

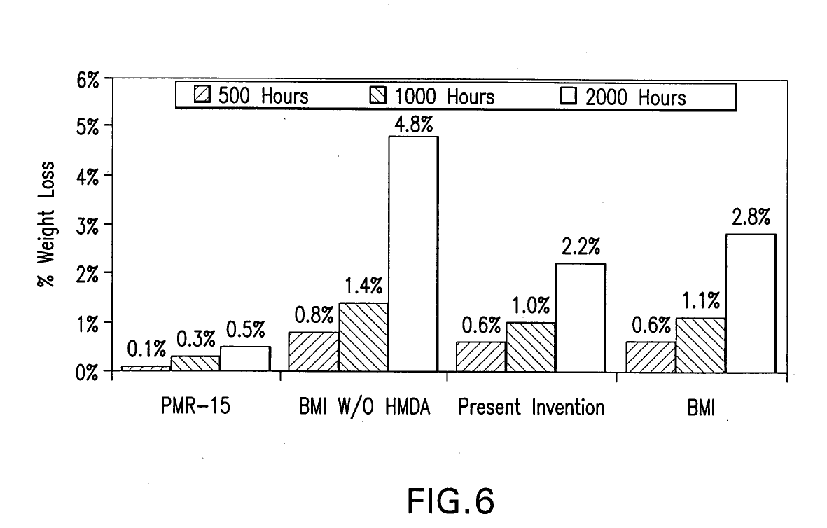

FIG. 6 shows the weight loss of just of 2% for composites using a BMI of the present invention (Ex. 11) after thermal aging for 2000 hours at 232° C. Weight loss for prior art BMI (CYCOM® 5250-4) (Ex. 8) is about 2.8%. Example 10 used specimens of BMI composite which did not contain any aliphatic BMI. Specimens were aged in an air circulating oven at 232° C. and the weight loss, T_{g} change and cross sections evaluated at intervals 500, 1000, and 2000 hours.

From FIG. 6 it can be appreciated that prior art epoxy resins provided good resistance to thermal aging, but at a lower Tg than required. BMIs with no aliphatic HMDA-BMI provided the high Tg, but with poor resistance to thermal aging. The BMI resin of the present invention surprisingly provides a higher Tg while still providing good resistance to thermal aging.

This data suggests that the high temperature capability of the present invention approaches that of PMR-15. The BMI based resin composites of the present invention provide a composite product with higher thermal stability than standard BMI resins while maintaining equivalent mechanical properties.

A cure cycle experiment on the present invention further illustrates the high temperature performance of the present invention. The anticipated service temperature required is in excess of 232° C.

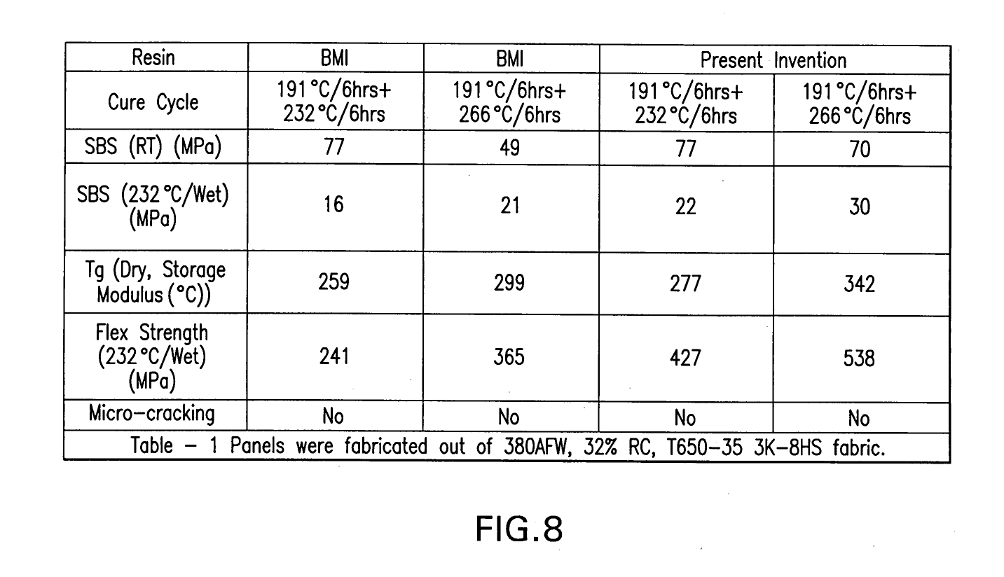

FIG. 8 illustrates a mechanical property comparison of a standard BMI resin based composite and the present invention at two different post-cures (232° C./6 hours and 266° C./6 hours). Mechanical properties were tested at room temperature and 232° C./wet. The initial cure of the present invention resin system is similar to prior art BMI at about 191° C./6 hrs.

The mechanical properties of the composite based upon the present invention at a 266° C./6 hrs post-cure were found to be better than a 232° C./6 hrs post-cure.

FIG. 8 shows that the 232° C. (wet) mechanical properties of the present invention were nearly double those of the prior art BMI resin based composite using a standard 450° F. post-cure. Flexural strength is dominated by failure on the compressive face at elevated temperature, and thus, is an excellent screen test for compression strength. In this test, the present invention demonstrated flexural strength more than twice that of the prior art BMI.

One of the further benefits of the present invention is the capability of RTM (resin transfer molding) processing due to its lower viscosity.

BMI resins of the present invention demonstrate a dry T_{g} about 100° F. higher than the standard BMI resins. The present invention also has about 40-45% higher SBS and 45-75% higher flex strength at 45° F./wet compared to standard BMI resins. Room temperature SBS was only 1 ksi lower than the standard product. Also there was no micro-cracking in any of the panels after thermal shocking them at 450° F. (5 cycles).

The present invention may be illustrated by reference to the following examples.

### EXAMPLES

For the following examples, T_{g}s were taken at the slope change of the storage modulus as measured on a TA Instruments DMA 2980 Dynamic Mechanical Analyzer at 5° C./min and 1 Hz.

Prepregs were manufactured at Cytec Engineered Materials (CEM) Anaheim plant on T650-35 3K-8HS or 2×2 Twill. Cured resin content was between 32% and 35% nominal.

Panels were fabricated in a high temperature, high pressure autoclave using various cure cycles. Panels produced have a target CPT of 0.01 to 0.015 inches.

### Example 1

An experiment was run that evaluated the viscosity reduction that occurs when substituting HMDA-BMI for BMI-H. The results show that a mixture containing more HMDA-BMI had a viscosity of 8883 Poise versus 100000 Poise for mixture containing less HMDA-BMI.

A first formulation was made by adding 138.63 grams of Matrimid 5292B at 160° F. in an aluminum mixing can. Next, 0.56 grams of 1,4-Napthaquinone was mixed into the resin. The temperature was increased to 235° F. and 27.72 grams of HMDA-BMI and 133.08 grams of MDA-BMI are dissolved into the resin. The resin is 100% homogenous and dissolved. The resin is cooled to room temperature.

Room temperature (27° C.) viscosity was measured on the uncured neat resin using an ARES-3 rheometer with the following settings: parallel plate, 25 mm diameter plates, 0.5 mm gap, Frequency of 10 rad/s, strain of 50% and time of 10 minutes. The room temperature viscosity was 100000 Poise.

A second formulation was made by adding 138.63 grams of Matrimid 5292B at 160° F. in an aluminum mixing can. Next, 0.56 grams of 1,4-Napthaquinone was mixed into the resin. The temperature was increased to 235° F. and 55.44 grams of HMDA-BMI and 105.36 grams of MDA-BMI are dissolved into the resin. The resin is 100% homogenous and dissolved. The resin is cooled to room temperature.

Room temperature viscosity was measured the same way as with the first formulation. The room temperature viscosity was 8883 Poise.

### Example 2

In an experiment of three resin mixes that were made into composites it was found that a formulation utilizing 5% HMDA-BMI had better mechanical properties. The only difference between the three mixes is that BMI-H is replaced by 5% and 10% of HMDA-BMI. The mechanical results indicate that a 5% modification had only slightly lowered elevated temperature mechanical properties then the formulation with only BMI-H.

A first formulation was made by adding 7.5 lbs of Matrimid 5292B at 160° F. in a 10-gallon Myer mixer. Next, 13.6 grams of 1,4-Napthaquinone was mixed into the resin. The temperature was increased to 200° F. and 22.47 lbs of MDA-BMI (90%<20 μm particle size) was slurry mixed into the resin. The resin was cooled to room temperature. The finished resin system was coated onto silicone coated release paper and used to prepare a carbon/graphite prepreg.

A laminate was made by plying together 8 plies of this prepreg. It was cured using an autoclave with 85 psi at 375° F. for 6 hours. A free-standing post-cure was completed at 510° F. in an oven for 6 hours.

T_{g}'s were taken at the slope change of the storage modulus as measured on a TA Instruments DMA 2980 Dynamic Mechanical Analyzer at 5° C./min and 1 Hz. The T_{g} is 662° F.

Short beam shear (SBS) testing was preformed using the ASTM 2344-98 test method at room temperature dry (RTD) and 475° F. wet (4 day water boil). The sample size was 0.25 in×0.086 in with a span to depth ratio of 4:1. The SBS strength was 8.7 ksi for RTD and 4.2 ksi for 475° F. wet.

A second formulation was made by adding 7.5 lbs of Matrimid 5292B at 160° F. in a 10-gallon Myer mixer. Next, 13.6 grams of 1,4-Napthaquinone was mixed into the resin. The temperature was increased to 235° F. and 1.5 lbs of HMDA-BMI is dissolved into the resin. The resin is 100% homogenous and dissolved at this stage. The temperature is decreased to 180° F. and 20.97 lbs of MDA-BMI (90%<20 μm) was slurry mixed into the resin. The resin is cooled to room temperature. The finished resin system was coated onto silicone coated release paper and used to prepare a carbon/graphite prepreg. Laminates were prepared out of this prepreg the same as with the first formulation.

T_{g} and SBS strength were measured the same as with the first formulation. The T_{g} was 681° F. and the SBS strength was 9.5 ksi for RTD and 4.1 ksi for 475° F. wet.

The mechanical results from this second formulation indicate that a 5% modification using HMDA-BMI did not lower the elevated temperature mechanical properties compared to the formulation with only BMI-H.

A third formulation utilizing 10% HMDA-BMI was also prepared, but testing of a resulting composite indicated slightly reduced mechanical properties.

### Example 3

A resin formulation mixed using HMDA-BMI was filmed and prepregged. The prepreg material had good tack and was easier to impregnate with less loss of tack then the formulation without HMDA-BMI, containing only BMI-H. The the out-life was similar to the material without HMDA-BMI, containing only BMI-H.

A formulation was made by adding 625 grams of Matrimid 5292B at 160° F. in an aluminum mixing can. Next, 2.5 grams of 1,4-Napthaquinone was mixed into the resin. The temperature was increased to 255° F. and 75 grams of HMDA-BMI and 597.5 grams of MDA-BMI are dissolved into the resin. The resin is 100% homogenous and dissolved at this stage. The temperature is decreased to 180° F. and 1150 grams of MDA-BMI (90%<20 μm) was slurry mixed into the resin. The resin is cooled to room temperature. The finished resin system was coated onto silicone coated release paper and used to prepare a carbon/graphite prepreg. The prepreg had good tack and drape and tack stability.

### Example 4

Three formulas illustrated in the following table were prepared using standard procedures. They were then made into composites using standard procedures and then tested using standard procedures.

Formula 1 was a BMI resin based prepreg containing no liquid BMI available as CYCOM® 5250-4 from Cytec Engineered Materials Inc. of Anaheim, Calif.

Formula 2 was a BMI resin based prepreg containing liquid TMH-BMI available as CYCOM® 5250-4LF from Cytec Engineered Materials Inc. of Anaheim, Calif.

Formula 3 was a version of the present invention made by adding 837 grams of Matrimid 5292B at 200° F. into an aluminum mixing can. Next, 3 grams of 1,4-Napthaquinone was mixed into the resin. The temperature was increased to 280° F. and 120 grams of Ultem 1000P was dissolved into the resin. The temperature was decreased to 235° F. and 300 grams of HMDA-BMI and 597.5 grams of MDA-BMI are dissolved into the resin. The resin is 100% homogenous and dissolved at this stage. The temperature is decreased to 180° F. and 15.33 grams of TDA-BMI and 29.67 grams of MDA-BMI are slurry mixed into the resin. The resin is catalyzed by adding 90 grams of premixed (95% Matrimid 5292B and 5% TPP). The resin is cooled to room temperature. The finished resin system was coated onto silicone coated release paper and used to prepare a carbon/graphite prepreg on IM7 fiber at 35% nominal resin content.

Laminates were prepared out of this prepreg and cured using an autoclave with 85 psi at 375° F. for 6 hours. A free-standing post-cure was completed at 440° F. in an oven for 6 hours.

Formula 3 prepreg tack, resin tan delta, and laminate mechanical properties (T_{g}, CAI, OHC and EDS) results were compared to two standard products (Cycom 5250-4 and Cycom 5250-4LF) an are reported in Table 1.

Tack was measured on the prepreg by means of touch. A lichert scale was used for tack (5 is high tack, 0 means no tack).

T_{g}'s were taken at the peak of the tan delta as measured on a TA Instruments DMA 2980 Dynamic Mechanical Analyzer at 5° C./min and 1 Hz. Wet Tg results were conditioned in boiling water for 4 days.

Room temperature (27° C.) tan delta was measured on the uncured neat resin using an ARES-3 rheometer with the following settings: parallel plate, 25 mm diameter plates, 0.5 mm gap, Frequency of 10 rad/s, strain of 50% and time of 10 minutes.

Compression after impact (CAI) values were measured using SACMA SRM02R94 test method with 1500 in-lb/in force impact.

Open hole compression (OHC) results were measured using SACMA SRM03R94 test method.

Edge delamination strength (EDS) results were measured using 5PTPTT01-A, Method 4.27 test method.

TABLE 1

| | Formula 1 | Formula 2 | | Formula 3 | |
|---|---|---|---|---|---|
| | No Liquid BMI | 3.3% | Liquid BMI | 10% | Liquid MDA-BMI |
| | | | TMH-BMI | | |
| | No Thermoplastic | 1.3% | Matrimid 9725 | 4% | Ultem |
| | 46% BMI Particles | 46% | BMI Particles | 45% | BMI Particles |
| | No Inhibitor | 0.1% | NQ | 0.1% | NQ |
| | No Cabosil | 3% | M5 Cabosil | No Cabosil | |
| Mechanical property | | | | | |

| Tack Lever after 1 day | 2 | | 3 | 5 | |
|---|---|---|---|---|---|
| Lichert Scale (0 to 5) | | | | | |
| Viscosity loss tangent | 129 | | Not tested | 3.3 | |
| of liquid component | | | | | |
| Dry Tg | 528° | F. | Not tested | 538° | F. |
| Wet Tg | 408° | F. | Not tested | 417° | F. |
| Compression after | 25.7 | KSI | Not tested | 25.3 | KSI |
| 1500 in-lb/in impact | | | | | |
| Open hole compression | 33.5 | KSI | Not tested | 33.1 | KSI |
| at 350° F. wet | | | | | |
| Edge delamination | 33 | KSI | Not tested | 33.6 | KSI |
| strength | | | | | |

Mechanical and viscosity tests were conducted on composites prepared from the above resins: The fiber is IM7 available from Hexcel. The nominal resin content is 35%.

Formula 3 demonstrated the best tack level after 1 day. Formula 3 demonstrated mechanical properties equivalent or better than formulations without HMDA-BMI.

### Example 5

A composite laminate was made from a prepreg incorporating the base resin of the present invention as described in the second formulation of Example 2 and subjected to thermal shock at 232° C. for 10 cycles. One cycle consisted of a room temperature (24° C.) sample being placed into a 232° C. oven for 30 minutes and then removing the sample for 30 minutes at room temperature. The coupons were polished and examined by microscopy. There were no micro-cracks (FIG. 5).

### Example 6

A formulation was made by adding 150 grams of Matrimid 5292B at room temperature into an aluminum mixing can. The temperature was raised to 121° C. Next, 1 gram of 1,4-Napthoquinone Hydrate and 290 grams of aromatic BMI are dissolved into the mixture. The mixture is 100% homogeneous and dissolved at this stage. The temperature is lowered to 71° C. and 460 grams of aromatic BMI particulate (90%<20 μm) is slurry mixed into the mixture. The finished resin system was coated onto silicone coated release paper and used to prepare a carbon/graphite prepreg.

A laminate was made by plying together 8 plies of this prepreg. It was cured using an autoclave with 85 psi at 375° F. for 6 hours. A free-standing post-cure was completed at 510° F. in an oven.

The laminate was cut into 4″×4″ samples and put into a 450° F. oven for 2000 hours. The sample was weighed before and after aging to determine the percent weight loss. The percent weight loss was 4.8%. Polishing a cross-section of the laminate revealed micro-cracking and oxidation throughout the thickness of the part.

### Example 7

A formulation was made by adding 150 grams of Matrimid 5292B at room temperature into an aluminum mixing can. The temperature was raised to 121° C. Next, 1 gram of 1,4-Napthoquinone Hydrate, 50 grams of HMDA-BMI and 240 grams of aromatic BMI are dissolved into the mixture. The mixture is 100% homogeneous and dissolved at this stage. The temperature is lowered to 71° C. and 460 grams of aromatic BMI (90%<20 μm) particulate is slurry mixed into the mixture. The finished resin system was coated onto silicone coated release paper and used to prepare a carbon/graphite prepreg.

A laminate was made by plying together 8 plies of this prepreg. It was cured using an autoclave with 85 psi at 375° F. for 6 hours. A free-standing post-cure was completed at 510° F. in an oven.

The laminate was cut into 4″×4″ samples and put into a 450° F. oven for 2000 hours. The sample was weighed before and after aging to determine the percent weight loss. The percent weight loss was 2.2%. Polishing a cross-section of the laminate revealed micro-cracking and oxidation only on the top and bottom plies.

### Example 8

Laminates were prepared according to Example 7. Glass transition temperature (T_{g}) was measured using a TA Instrument DMA 2980 Dynamic Mechanical Analyzer at 5° C. (9° F.)/min and 1 Hz. T_{g} data is the onset temperature from the storage modulus curve. The T_{g} for this material was 650° F.

Short beam shear (SBS) testing was preformed using the ASTM 2344-98 test method. The sample size was 0.25 in×0.086 in with a span to depth ratio of 4:1. The SBS strength was 70 MPa.

### Example 9

A formulation was made by adding 400 grams of Matrimid 5292B at room temperature into an aluminum mixing can. The temperature was increased to 121° C. and 200 grams of Aromatic BMI was dissolved into the mix. The mixture is 100% homogeneous and dissolved at this stage. The temperature is cooled to 71° C. and 400 grams of Aromatic BMI (90%<20 μm) is slurry mixed into the mix. The finished resin system was coated onto silicone coated release paper and used to prepare a carbon/graphite prepreg.

A laminate was made by plying together 8 plies of this prepreg. It was cured using an autoclave with 85 psi at 375° F. for 6 hours. A free-standing post-cure was completed at 510° F. in an oven.

Tg and SBS were measured using the same method as Example 8. For this material the T_{g} was 600° F. and the SBS strength was 49 MPa.

### Example 10

A formulation was made by adding 400 grams of Matrimid 5292B at room temperature into an aluminum mixing can. The temperature was increased to 121° C. and 600 grams of Aromatic BMI was dissolved into the mix. The mixture is 100% homogeneous and dissolved. The finished resin system was coated onto silicone coated release paper and used to prepare a carbon/graphite prepreg. This prepreg had no tack and no drape.

### Example 11

A formulation was made by adding 400 grams of Matrimid 5292B at room temperature into an aluminum mixing can. The temperature was increased to 121° C. and 100 grams of HMDA-BMI and 500 grams of Aromatic BMI are dissolved into the mix. The mixture is 100% homogeneous and dissolved. The finished resin system was coated onto silicone coated release paper and used to prepare a carbon/graphite prepreg. This prepreg had good tack and drape.

### Example 12

A composite prepreg was prepared in accordance with Example 6. This material had no tack and no drape.

### Example 13

A composite prepreg was prepared in accordance with Example 7. This material had good tack and drape.

What is claimed is:

1. A thermosetting bismaleimide resin system, comprising:
a base resin system comprising a liquid phase and a solid phase;
an aliphatic BMI in the liquid phase forming about 2 wt % to about 20 wt % of the base resin system;
an aromatic BMI, wherein about 1% to about 45% the aromatic BMI remains in the solid phase at the slurry mixing temperature, forming about 50 wt % to about 90 wt % of the base resin formulation.

2. The thermosetting bismaleimide resin system of claim 1 wherein the aliphatic BMI is substantially a monomer.

3. The thermosetting bismaleimide resin system of claim 1 further comprising a thermoplastic.

4. The thermosetting bismaleimide resin system of claim 1 wherein the aliphatic BMI is HMDA-BMI.

5. The thermosetting bismaleimide resin system of claim 1 further comprising an inhibitor.

6. The thermosetting bismaleimide resin system of claim 1 wherein the slurry mixing temperature is between 140° F. and 180° F.

7. The thermosetting bismaleimide resin system of claim 1 wherein about 90 wt % to about 100 wt % of the solid phase aromatic BMI have a particle size of 20μ or less.

8. A thermosetting bismaleimide resin system, comprising:
a base resin system comprising only a liquid phase at the mixing temperature;
an aliphatic BMI in the liquid phase that is substantially a monomer.

9. The thermosetting bismaleimide resin system of claim 11 further comprising about 1 wt % to about 10 wt % of a thermoplastics.

10. The thermosetting bismaleimide resin system of claim 12 further comprising an aromatic BMI.

11. A thermosetting resin comprising:
about 2 wt % to 20 wt % aliphatic BMI;
about 15 wt % to 60 wt % olefinic co-reactant;
about 20 wt % to 80 wt % aromatic BMI; and
wherein the resin displays improved stability to aging at about 350° F. to about 600° F.

12. The thermosetting resin of claim 11 wherein weight loss after thermal aging is less than 2.8%.

13. The thermosetting resin of claim 11 further comprising a catalyst.

14. The thermosetting resin of claim 11 further comprising an inhibitor.

15. The thermosetting resin of claim 11 further comprising a flow control agent.

16. The thermosetting resin according to claim 11 further comprising about 0.5 wt % to about 20 wt % thermoplastic.

17. The thermosetting resin according to claim 11 further comprising wherein total resin modifiers are about 30 wt % or less.

18. The thermosetting resin according to claim 11 wherein the tack is increased over an equivalent BMI resin formulation comprising only aromatic BMI.

19. The thermosetting resin of claim 11 wherein the olefinic co-reactant is 2,2′ diallylbisphenol A or alkenylphenoxybenzophones.

20. A thermosetting resin system comprising:
about 70 wt % to about 85 wt % total BMI;
about 15 wt % to about 30 wt % olefinic co-reactant;
wherein the resin has Tg between about 500° F. and 750° F.
